(19) United States
(12) Patent Application Publication
(10) Pub. No.: US 2012/0159580 A1
(43) Pub. Date: Jun. 21, 2012

(54) Method of Establishing Trusted Contacts With Access Rights In a Secure Communication System

(76) Inventor: Paul Anthony Galwas, St. Ives (GB)

(21) Appl. No.: 13/304,599

(22) Filed: Nov. 25, 2011

Related U.S. Application Data
(60) Provisional application No. 61/416,854, filed on Nov. 24, 2010.

(51) Int. Cl. H04L 9/00

(52) U.S. Cl. 726/4

(57) ABSTRACT

A method of establishing trusted contacts with access rights in a secure communication system. The method includes establishing the trustworthiness of an untrusted call received from another end point in a secure communication system and storing information corresponding to the end point as a trusted contact entry in a database if the trustworthiness of the end point is established. Access rights of the trusted contact are determined and stored in the database and any time restrictions are determined and stored in the database.

### CROSS-REFERENCE TO RELATED APPLICATIONS

The application claims the benefit of priority of U.S. Provisional Application Ser. No. 61/416,854 filed on Nov. 24, 2010, the disclosure of which is incorporated herein by reference in its entirety.

### FIELD OF THE INVENTION

The present disclosure relates to providing voice and other real-time communications of digital data over networks. In particular, the present disclosure relates to establishing trusted contacts between end points in a secure communication system.

### BACKGROUND OF THE INVENTION

In network systems, such as mobile telephony, it is important to perform by protocols that establish secure real-time communication of data over a network. There is an established field of real-time communications over Internet Protocol (IP) networks, which underpins widespread applications such as Voice over IP (VoIP). There are standard protocols such as Session Initiation Protocol (SIP) and Real-Time Transport Protocol (RTP) which support unencrypted real-time traffic. Secure RTP (SRTP) has been extended to encrypt real-time traffic. However, none of these protocols consider establishing a community of trusted contacts to further provide secure communications.

The present disclosure is directed toward, but not limited toward, improving the above noted problems by establishing trusted contacts between end points in a secure communication system.

### SUMMARY OF THE INVENTION

Exemplary embodiments disclosed herein provide a method of establishing trusted contacts with access rights in a secure communication system. The method, for example, includes establishing the trustworthiness of an untrusted call received from another end point in a secure communication system and storing information corresponding to the end point, as a trusted contact entry in a database if the trustworthiness of the end point is established.

The method determines access rights of the trusted contact and storing the access rights in the database with the stored information corresponding to the end point and determines whether any of the access rights are associated with a time restriction, and if so, the time restriction is stored in the database with the trusted contact entry.

### BRIEF DESCRIPTION OF THE DRAWINGS

FIG. 1 is a block diagram illustrating an exemplary embodiment of a communication system as disclosed herein.

FIG. 2 is a block diagram illustrating an exemplary embodiment of a trusted contact database.

FIG. 3 is a flow chart illustrating an exemplary representation of a verification process of an authentication value.

FIG. 4 is a flow chart illustrating an exemplary representation of using access rights in the trusted contact database to control data communications.

### DETAILED DESCRIPTION

The present disclosure describes a communication protocol for providing secure real-time communications in a network system. The protocol is bandwidth efficient and uses minimal data and messages to effectuate secure real time communications in the network. The protocol performs mutual authentication and generates multiple shared secrets for encrypted communications.

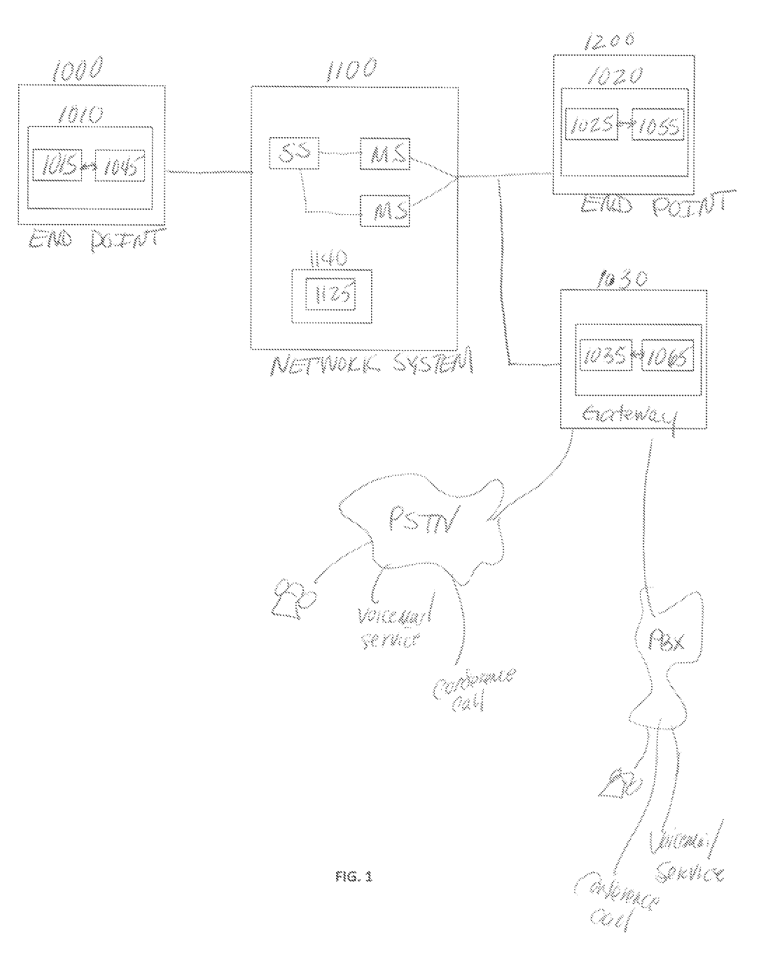

FIG. 1 is a diagram illustrating an exemplary embodiment of a communication system. The system includes end point 1010 communicating over wireless network 1000 with network system 1100, and end point 1020 communicating with the network system over wireless network 1200. The network system interconnects two end points in the communication system, and the communication system may include two or more end points.

End point 1010 can be, for example, a mobile end point, which includes mobile equipment (e.g., mobile phone) equipped with encryption modules. The encryption modules provide encryption and decryption functions for voice data in real time and establish a secure communication link with another end point in the communication system. The encryption modules can be processors embedded with computer readable instructions that when executed perform encryption and decryption functions.

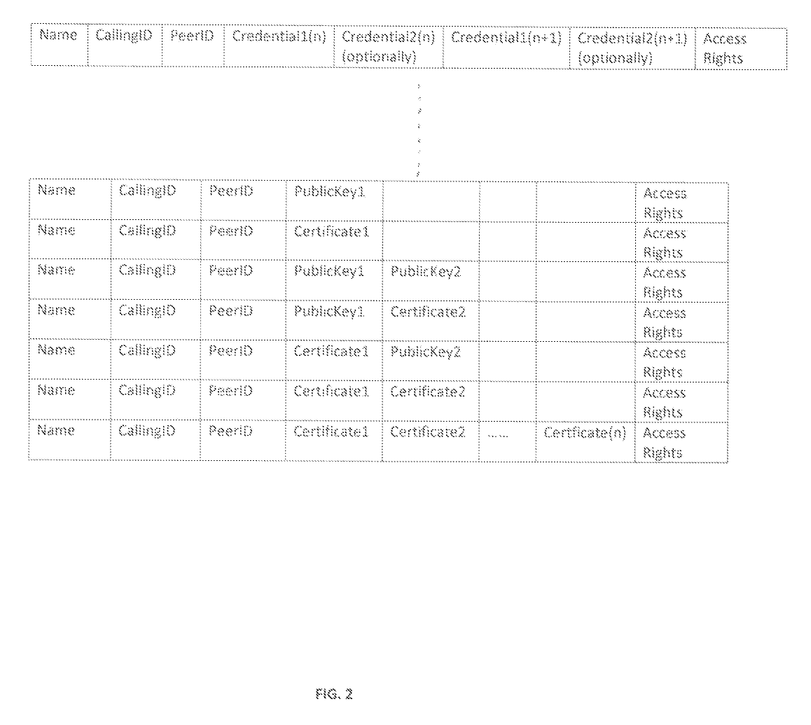

End point 1010 includes trusted contact database 1015, which stores a list of trusted contacts (1 through n), and a database manager 1045. Each trusted contact contains for a given end-point: name, CallingID, PeerID, Credential1 and optionally Credential2, and access rights, as illustrated in FIG. 2, where name is a user-defined string to identify the contact, CallingID can be used as a CallerID or CalleeID, and CredentialZ is AAZpub, or Cert-AAZ, and Z corresponds to end point 1010, end point 1020 or gateway 1030.

Database manager 1045 includes one or more microprocessors, computer readable memory (e.g., read-only memory (ROM) and random access memory (RAM)), mechanisms and structures for performing I/O operations. Database manager can execute an operating system for execution on the one or more microprocessors and an application program for controlling the operations of trusted contact database 1015. The application program can be developed using any suitable computer programming language, such as, for example, Java programming.

End point 1010 includes a storage device (not shown), which can be implemented with a variety of components or subsystems including, for example, a magnetic disk drive, an optical drive, flash memory, or any other devices capable of persistently storing information. The storage device stores the trusted contact database.

The PeerID identifies the device to the media server and is generated using a random number generator. In another exemplary embodiment, the PeerID is derived from a public key of an asymmetric cryptographic key pair that an end point generates when it is created. The PeerID of an end point is independent of the IP address and is used to identify media messages from a corresponding end point in the communication system.

CallerID is the secure phone number by which the end point or gateway initiating a call is addressed in the network that carries encrypted calls. CalleeID is the secure phone number by which the end point or gateway receiving the call is addressed in the network that carries encrypted calls.

In another exemplary embodiment, CallerID and CalleeID are identified by a trusted range, which is a heterogeneous set of elements that can specify all secure phone numbers that start with a specified prefix and/or all secure phone numbers in a specified range.

AAZpub is the public key value of device Z. Cert-AAZ is the digital certificate associated with device Z and Z corresponds to end point 1010, end point 1020 or gateway 1030. The digital certificate can identify a device, person, an attribute of either (e.g. a CallingID, email address, PeerID) or the combination.

Access rights are a set of permissions associated with a trusted contact. For example, the permissions might include the right to make or receive a secure call message, such as, email, SMS or IM, to see a phone number or other identifier, to access a voicemail box, or conference bridge and to transfer a call. The access rights can apply only for a specified time interval, such as time of day or week and the access rights can have an associated trust level, which is a positive integer.

Each end point has an associated end point trust level, which is a positive integer. An end point with a higher trust level is assumed to be more trustworthy than one with a lower trust level. The trust level is optionally stored in the trusted contact database entry associated with the end point. The trust level can be set when the trusted contact is defined, either by the user on the end point, or in a central directory.

Access rights can optionally include a trust level. In particular, different access rights may apply for different trust levels. For example, an end point may have the right to call an end point with the same trust level, but not to call an end point with a higher trust level.

Before performing a function that involves another end point, an end point confirms that the trust level of the access right associated with the other end point is greater than or equal to that of the end point trust level. Otherwise it denies the function. When a trust level is defined for the trusted contact and its access rights, the level of the access right takes precedence.

End point 1020 can be, for example, another mobile end point, such as end point 1010, or a gateway device, such as gateway 1030. End point 1020 includes a trusted contact database 1025 as described above. Gateway 1030 connects a traditional phone system, such as, for example, Public Switched Telephone Network (PSTN) and Private Branch Exchange (PBX) to network system 1100. The gateway converts the PSTN or PBX telephone traffic into an IP format for transmission over an IP network.

Gateway 1030 is equipped with an encryption module to facilitate encryption and decryption functions. Transparent point-to-point encryption is provided between end point 1010 and end point 1020, and between end point 1010 and gateway 1030. Gateway 1030 includes a trusted contact database 1035 and database manager 1045 as described above.

The encryption modules may use redundant encryption schemes for session, authentication, digesting and/or key exchange. Preferred embodiments use two strong algorithms at the same time in series. The encryption of the data may be performed using any known cryptography algorithm, such as, for example, Elliptic curve Diffie-Hellman (ECDH), Rivest, Shamir and Adleman (RSA), Advanced Encryption Standard (AES), Digital Signature Algorithm (DSA), etc.

In an exemplary embodiment, trusted contacts are stored in a central directory (e.g., Lightweight Directory Access Protocol (LDAP) or Microsoft Active Directory). The data is mastered there and distributed using standard means to end points. The data can be associated with other data elements associated with the end point and/or end point user.

Networks 1000 and 1200 are wireless network systems, such as, for example, Global Systems for Mobile Communication (GSM), Enhanced Data Rates for GSM Evolution (EDGE), General Packet Radio Service (GPRS), 3G GSM, HSPA, UMTS, CDMA and Wi-Fi.

Network system 1100 is a wired network system, such as, for example, an Internet Protocol (IP) system. The network system may include one or more signaling servers and one or more media servers. An end point sends a request to the signaling server to make a call or send a message to another end point. The signaling server sets up the call, telling each end point to contact the same media server. The end points send the real-time data to each other through the media server. The media server uses media protocols for receiving voice data and sending it across the network.

Storage device 1140 can be implemented with a variety of components or subsystems including, for example, a magnetic disk drive, an optical drive, flash memory, or any other devices capable of persistently storing information. Storage device includes device database 1125, which contains a list of all the DeviceIDs known to the system.

The architecture shown in FIG. 1 allows for communication (e.g., data transmission, phone call, and video) between two end points or between an end point and a gateway in the system. The real-time communications between two end points or between an end point and a gateway are encrypted using one or more session keys that are derived from a shared secret known only to the end points. However, before an encrypted path between end points or between an end point and a gateway is established, mutual authentication must occur as described in co-pending application “A Method of Providing Real-Time Secure Communication between End Points in a Network”, U.S. application Ser. No. ______ filed on ______.

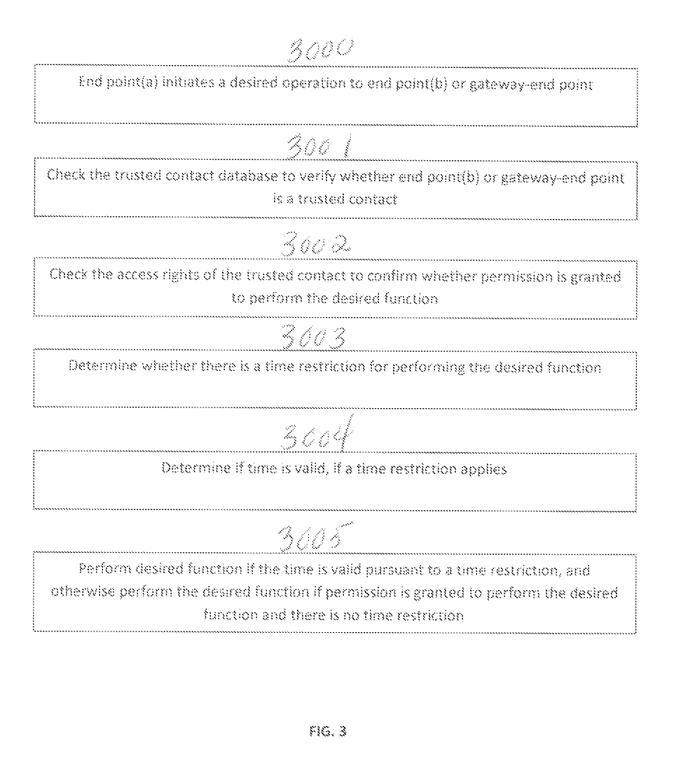

During the mutual authentication process, authentication values AA1-Auth and AA2-Auth are verified for the end points/gateway corresponding to the path being created using an algorithm, for example, as illustrated in FIG. 3.

The algorithm, as illustrated in FIG. 3, includes, for example, the following:
At step 301, if end point 1010 is the Caller (A) (i.e., the initiator end point), find the trusted contact that matches the CalleeID corresponding to end point 1020. If end point 1020 is the Callee (B) (i.e., the receiver end point), find the trusted contact that matches the CallerID corresponding to end point 1010, which is obtained from a call request2 message.
At step 302, determine if a match is found.
If a match is found, at step 303, compute the verification results as follows:
   a. If a match is found for end point B (1020), ResultA=(CallerID from call request2 message matches CalleeID from the trusted contact)
   b. if a match is found for end point A (1010), ResultA=(CalleeID matches CallerID from the trusted contact)
   c. ResultB=verify AAZ-Auth (e.g., AA1-Auth (1020)) using the CredentialZ from the trusted contact, using a standard cryptographic verification algorithm for AAZ (e.g. AA1), Z=1 or 2.
   d. VerificationResultZ=ResultA AND ResultB
   e. If VerificationResultZ is TRUE, set TrustedCallZ to TRUE
If no match is found, at step 304, set the verification result to TRUE and the TrustedCallX to False.
ResultX and TrustedCallX (X=A or B), VerificationResultZ (Z=1 or 2) are logical values, with values TRUE or FALSE.

After both verifications of AA1-Auth and AA2-Auth are completed, the end point/gateway computes a trusted status for the call, TrustedCall=TrustedCall1 AND TrustedCall2, which can be TRUE or FALSE. The system displays the trusted status of the call, TrustedCall, to the user.

After a call completes, if TrustedCall is FALSE, the end point/gateway can add a new trusted contact to the trusted contact database (i.e., locally-defined trusted contact) by performing the following:
1) Ask the user to input a name by which they will identify the trusted contact.
2) Establishing the trustworthiness of the call.
3) Optionally asks the user to specify which access rights apply to the trusted contact.
4) Optionally asks the user to specify the trust level of the end point.
5) Store a new trusted contact in the trusted contact database as illustrated in FIG. 2.

The trustworthiness of a call can be established using Trust on First Use (TOFU) or public key infrastructure or a combination thereof. Trust on first use (TOFU) is a process to initiate trust between two end-points without requiring any external trusted parties, such as certificate authorities (i.e., digital certificates). The user of each end point is responsible for making trust-related decisions and they can establish trust scalably and flexibly, for example, using out-of-band mechanisms to support their decisions.

Public key infrastructure (PKI), comprises a central certificate authority (CA) that is responsible for certifying trusted information, such as public keys. End-points must have a relationship with the CA before they can interoperate. In this case, one or more digital signatures are verified.

In a combination mode, each end point is part of a public key authority (PKI) or it is not. When it is not, TOFU is used to establish a trusted contact. Each end point on a call can use either mode to trust the other end point.

If an end point is part of a PKI, then the key-pair that it uses to authenticate itself to another party (the trusting end point) is associated with a digital certificate that is issued by a certificate authority (CA).

When the trusting end point receives the digital certificate for the first time through the end-to-end protocol, so that TrustedCall is FALSE, the end point:
1. Validates the certificate, by traversing the chain of trust to the CA and/or checking the certificate revocation list (CRL) and/or using on-line certificate status protocol (OCSP).
2. If the validation succeeds, the contact is trusted implicitly. After the call completes, the end point/gateway can add a new trusted contact by performing the following:
   a. Either asks the user to input a name by which they will identify the trusted contact; or take the name directly from an attribute in the digital certificate.
   b. Optionally asks the user to specify which access rights apply to the trusted contact.
   c. Optionally asks the user to specify the trust level of the end point.
   d. Stores a new trusted contact in the trusted contact database.
3. If the validation fails
   a. in one case the call terminates and the user is not prompted to add a secure contact, so cannot add the end point as a secure contact;
   b. in another case, the process is the same as for a TOFU, as described below and in paragraph [0035].

If an end point is not part of a PKI, then the end point uses a public key (not a certificate) to authenticate itself to the trusting end point.

When the trusting end point receives the public key for the first time through the end-to-end protocol, the process described in paragraph [00034] will result in TrustedCall is FALSE, then after the call completes, the end point/gateway can add a new trusted contact:
1. Ask the user to confirm whether they wish to trust the endpoint, and hence the trustworthiness of the call; if the user say ‘no’, exit
2. Ask the user to input a name but which they will identify the trusted contact
3. Optionally asks the user to specify which access rights apply to the trusted contact
4. Optionally asks the user to specify the trust level of the end point.
5. Store a new trusted contact in the trusted contact database.

When a trusted contact is defined, or at any time during its lifetime, the associated access rights can be defined:
a. From a default set of access rights that are stored on the end point or mastered in the central directory;
b. By asking the user of an end point to specify which rights may apply when defining or editing a trusted contact; or
c. By the central administrator who defines and manages trusted contacts in a central database.

Alternatively, an end point can become a trusted contact when a central administrator compiles a list of trusted contacts in a central directory (i.e., centrally-defined contact), which are later distributed to a set of end points. To add an end point to the directory:
1. The end point securely sends (directly or indirectly) its {Calling ID, PeerID, {Credential 1, . . . },} to the central administrator
2. The central administrator optionally adds the name
3. The central administrator optionally adds the access rights
4. The central administration optionally adds a trust level.
5. The central administrator puts the record into the central directory.

An end point can populate its trusted contact database partially or fully from the central directory, using standard mechanisms such as LDAP, and partially or fully by adding local trusted contacts.

When a centrally-defined contact clashes either the centrally-defined trusted contact takes precedence; or the user is asked to decide which should take precedence.

The central administrator can change an access right associated with a trusted contact in the central directory.

In another exemplary embodiment, the central administrator can prevent a user from changing access rights associated with a trusted contact.

In another exemplary embodiment, a user can change an access right associated with a trusted contact of the end point.

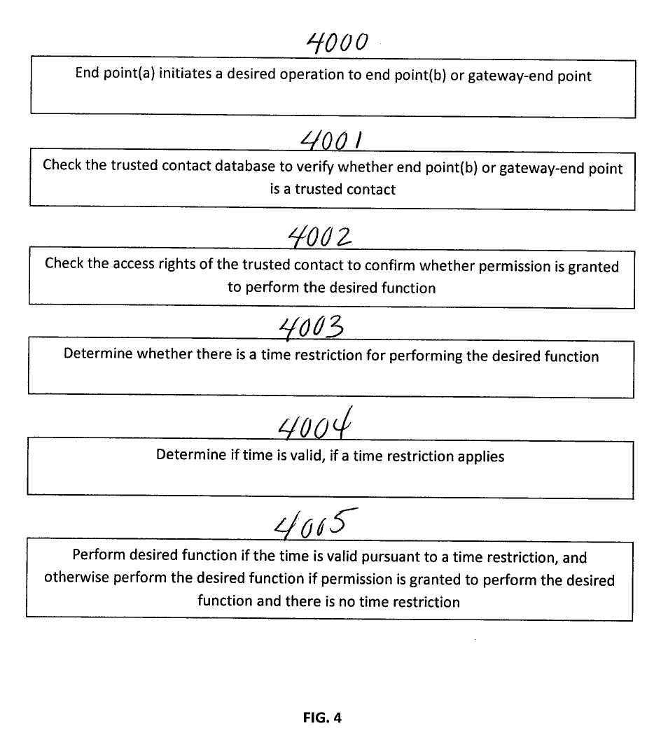

Once the trusted contact database is established, communications between end points or between an end point and gateway are performed as illustrated in FIG. 4. At step 4000 an end point/gateway (e.g. end point 1010) initiates a desired operation (e.g., a call) to another end point (e.g. end point 1020). End point 1010 initiates the desired operation by sending the name associated with the end point/gateway and the desired operation to the database manager (e.g. database manager 1045).

At step 4001, database manager checks the database (e.g. database 1015) to verify whether the name associated with the end point/gateway is a trusted contact. Since, only trusted contacts are listed in the trusted contact database, the database manager determines if the name is listed in the database, and if it is not, then the associated end point/gateway is not a trusted contact and communication is not allowed. The end point can become a trusted contact by the user of another end point adding it following a call as described above or when it is registered in a central directory.

If the end point is a trusted contact, the database manager confirms whether permission is granted to perform the desired operation, at step 4002. The database manager checks the access rights associated with the trusted contact to determine if the desired operation is allowable, and if the desired operation is not allowed, communication of the sort desired is prevented.

If the desired operation is allowed, the database manager determines whether there is a time restriction for the desired operation, at step 4003. Time restrictions are stored in the trusted contact database with the access rights. The database manager checks the access rights to determine if the desired operation has a time restriction.

If a time restriction applies, the database manager determines if the time is valid, at step 4004. If no time restriction applies and the desired function is allowed, then the desired function is performed, at step 4005. If a time restriction applies and the time is determined as valid, then the desired operation is performed, at step 4005.

As disclosed herein, embodiments and features of the invention can be implemented through computer hardware and/or software. Such embodiments can be implemented in various environments, such as networked and computing-based environments. The present invention is not limited to such examples, and embodiments of the invention can be implemented with other platforms and in other environments.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

What is claimed:

1. A method of establishing trusted contacts with access rights in a secure communication system, comprising the steps of:
establishing, by an end point, the trustworthiness of an untrusted call received from another end point in the secure communication system;
storing information, by a database manager, corresponding to the end point, as a trusted contact entry in a database if the trustworthiness of the end point is established;
determining access rights, by the end point, of the trusted contact and storing the access rights in the database with the stored information corresponding to the end point; and
determining, by the end point, whether any of the access rights are associated with a time restriction, and if so, storing the time restriction in the database with the trusted contact entry.

2. The method of claim 1, wherein the trustworthiness of an untrusted call is established using trust on first use (TOFU) or public key infrastructure (PKI).

3. The method of claim 1, wherein the stored information includes name, Calling ID, PeerID, Credential1 and optionally Credential2.

4. The method of claim 1, wherein the trust status of a call is displayed to a user.

5. The method of claim 3, wherein the Calling ID of the trusted contact is a heterogeneous set of elements.

6. The method of claim 5, wherein the heterogeneous set of elements are all secure phone numbers that start with a specified prefix.

7. The method of claim 5, wherein the heterogeneous set of elements are all secure phone numbers in a specified range.

8. The method of claim 1, wherein each end point and gateway in the secure communication system includes a database of trusted contacts.

9. The method of claim 1, wherein trusted contacts are stored in a central directory and distributed to end points.

10. The method of claim 1, wherein an access right includes an associated trust level.

11. A method of communicating in a secure communication system with trusted contacts and access rights, comprising the steps of:
initiating, by an end point, a desired operation to another end point in the communication system;
checking, by a database manager, a database of trusted contacts to verify whether the name associated with the other end point is listed in the database;
checking, by the database manager, the access rights associated with the other end point, if the name of the end point is listed in the database;
determining, by the database manager, whether the permission is granted to perform the desired operation from the associated access rights;
determining, by the database manager, whether there is a time restriction for the desired operation if permission is granted to perform the operation; and
performing the desired operation if a time restriction applies and an actual time is determined as valid, otherwise performing the desired operation if no time restriction applies and permission is granted to perform the desired operation.
